(19) United States
(12) Patent Application Publication
(10) Pub. No.: US 2024/0241241 A1
(43) Pub. Date: Jul. 18, 2024

(54) VEHICLE OCCUPANT DETECTION SYSTEM

(71) Applicant: Ford Global Technologies, LLC, Dearborn, MI (US)

(72) Inventors: Stuart C. Salter, White Lake, MI (US); Brad Ignaczak, Canton, MI (US); Grant Scott, III, Dearborn, MI (US); Brendan Diamond, Grosse Pointe, MI (US); David Celinske, Wolverine Lake, MI (US); Leo James Lanctot, South Lyon, MI (US)

(73) Assignee: Ford Global Technologies, LLC, Dearborn, MI (US)

(21) Appl. No.: 18/154,812

(22) Filed: Jan. 14, 2023

(51) Int. Cl. G01S 13/04; G01S 13/88

(52) U.S. Cl. CPC G01S 13/04; G01S 13/88

(57) ABSTRACT

A vehicle having a scanning unit and a detection unit is disclosed. The scanning unit may scan and detect an occupant presence in a vehicle interior portion. The detection unit may detect a trigger event associated with the vehicle. The vehicle may further include a processor configured to obtain a trigger event information from the detection unit. The processor may further determine a scanning unit setting based on the trigger event information. The scanning unit setting may be associated with at least one of a scan order, a fidelity mode and a scan frequency for the scanning unit. The processor may determine the scanning unit setting such that a vehicle power consumption may be optimized. The processor may further output a control signal to the scanning unit to scan the vehicle interior portion based on the determined scanning unit setting.

### TECHNICAL FIELD

The present disclosure relates to a vehicle occupant detection system, and more particularly, to a zonal occupant detection radar system that detects occupants in a vehicle.

### BACKGROUND

Many modern vehicles use occupant detection systems to detect occupant presence inside a vehicle. An occupant detection system generally makes use of radar sensors that scan vehicle interior and detect occupant presence. The radar sensors are typically installed inside the vehicle and may include a plurality of transmitters and receivers. The transmitters transmit radar beams/waves inside the vehicle that may reflect after striking an object, e.g., an occupant. The system may receive the reflected waves via the receivers to ascertain an occupant presence (or absence) inside the vehicle.

The occupant detection system may operate in the vehicle while the vehicle is stationary (e.g., parked) or in motion. The system provides many benefits to vehicle users. For example, the system may enable a user to detect if someone (e.g., a child or a pet) is left behind in the vehicle unintentionally when the user parks the vehicle. Further, the system may alarm the user if an occupant (e.g., an unknown person) enters a parked vehicle.

While the system may be advantageous to the users, conventional occupant detection systems consume considerable vehicle power while in operation. For example, some conventional occupant detection systems continue to scan the vehicle interior periodically (e.g., every 100 millisecond) for a substantial duration (e.g., up to 30 minutes) when the systems detect absence of occupants. Such long duration scanning may drain vehicle power, which may affect vehicle performance.

Thus, there is a need for an occupant detection system that optimizes power consumption in the vehicle.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle in which techniques and structures for providing the systems and methods disclosed herein may be implemented.

FIG. 2 depicts a system to optimize a scanning unit operation in a vehicle, in accordance with the present disclosure.

FIGS. 3A, 3B and 3C depict example embodiments of a trigger event in accordance with the present disclosure.

FIG. 4 depicts an example snapshot of a vehicle interior portion segregated into different zones, in accordance with the present disclosure.

FIG. 5 depicts a flow diagram of an example method for optimizing the scanning unit operation in the vehicle, in accordance with the present disclosure.

### DETAILED DESCRIPTION

### Overview

The present disclosure describes a vehicle having an occupant detection system. The occupant detection system may include a scanning unit having one or more radar sensors. The radar sensor may be configured to scan a vehicle interior portion (e.g., a vehicle cabin) and determine an occupant presence or absence inside the vehicle, responsive to receiving a trigger event. Examples of the trigger events include, but are not limited to, a vehicle door opening or closing, a user with a key fob approaching the vehicle, switching ON or OFF of a vehicle heating, ventilation, and air conditioning (HVAC) system, and/or the like. Responsive to detecting the occupant presence or absence, a system processor may control operations of a plurality of vehicle units. For example, the system processor may switch OFF a vehicle rear AC or infotainment display screen when the scanning unit detects no occupant presence at vehicle rear sitting area.

The system processor may be further configured to control scanning unit operation based on a trigger event type. Specifically, the system processor may adjust or modify scanning unit operation setting based on different trigger event types. For example, the system processor may modify a scan frequency, a scan order in the vehicle interior portion, a fidelity or operation power mode, etc. associated with the scanning unit based on the trigger event type.

In some aspects, the system processor may adjust the scan order such that the scanning unit may scan those vehicle areas first where a probability of detecting an occupant is high. The system processor may determine the scan order based on historical vehicle usage and/or the trigger event type. For example, the system processor may cause the scanning unit to scan a driver sitting area first, if the trigger event is associated with an opening of a vehicle driver door. The system processor may deactivate the scanning unit or cause the scanning unit to cease subsequent scans when the occupant presence is detected.

In further aspects, the system processor may adjust the scan frequency such that the scanning unit may scan more frequently when the trigger event is detected, and less frequently when no trigger event is detected. For example, the system processor may increase the scan frequency when a vehicle door is closed, and may gradually reduce the scan frequency if the system processor does not detect any further trigger event.

In additional aspects, the system processor may cause the scanning unit to switch operations between a low fidelity/power mode and a high fidelity/power mode, based on the trigger event type. For example, the system processor may cause the scanning unit to scan in the high fidelity/power mode when a trigger event associated with vehicle door closing is detected, and may cause the scanning unit to switch to the low fidelity/power mode for subsequent scans if no additional trigger event is detected.

The present disclosure provides a vehicle occupant detection system that optimizes vehicle power consumption. The system switches OFF vehicle units when the system detects that no occupant is present in the vehicle or at certain vehicle sitting areas, thus saving vehicle power. Further, the system optimizes the vehicle power consumption by controlling the scanning unit operation. For example, the system saves vehicle power by switching the scanning unit operation mode to the low fidelity/power mode when operation in the high fidelity/power may not be required. The system further conserves vehicle power by controlling the scan frequency and/or the scan order within the vehicle, and ceases subsequent scans when the occupant presence is detected.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

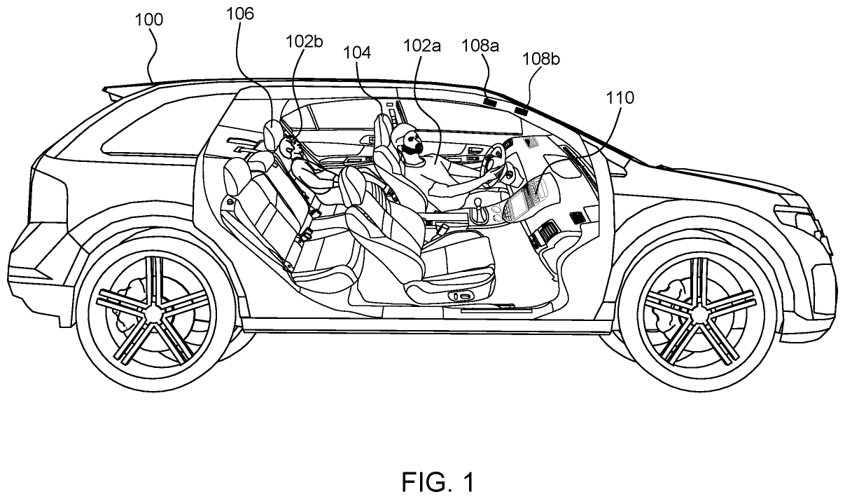

FIG. 1 depicts an example vehicle 100 in which techniques and structures for providing the systems and methods disclosed herein may be implemented. The vehicle 100 may take the form of any passenger or commercial vehicle such as, for example, a car, a work vehicle, a crossover vehicle, a van, a minivan, a taxi, a bus, etc. Further, the vehicle 100 may be a manually driven vehicle, and/or may be configured to operate in a fully autonomous (e.g., driverless) mode or a partially autonomous mode, and may include any powertrain such as, for example, a gasoline engine, one or more electrically-actuated motor(s), a hybrid system, etc.

As shown in FIG. 1, one or more users 102a, 102b (collectively referred to as a user 102) may be present in an interior vehicle portion (e.g., a vehicle cabin). For example, an adult (the user 102a) may be located at a vehicle driver sitting area 104, and a child (the user 102b) may be located at a vehicle middle/rear sitting area 106.

The vehicle 100 may be configured to detect user 102 presence in the vehicle 100 by using one or more vehicle sensory devices. For example, the vehicle 100 may include one or more scanning units 108a, 108b (collectively referred to as a scanning unit 108) that may be installed in the vehicle 100, and may scan the interior vehicle portion to detect the user 102 presence in the vehicle 100. The scanning unit 108 may be installed at a front vehicle portion, e.g., near a vehicle windscreen, or in any other location in the interior vehicle portion.

The vehicle 100 may optimize usage of a plurality of vehicle units or components based on detection of the user 102 presence (or absence) in the vehicle 100. For example, the vehicle 100 may automatically switch ON a rear air-conditioning (AC) vent when the vehicle 100 detects the user 102b presence at the vehicle rear sitting area 106. On the other hand, the vehicle 100 may switch OFF the rear AC vent when the vehicle 100 detects absence of occupant in the vehicle rear sitting area 106. As further examples, the vehicle 100 may automatically switch ON or OFF a plurality of vehicle units such as vehicle interior lights, a vehicle infotainment system 110, vehicle sitting area buckle sensors, etc., based on user 102 presence or absence in the vehicle 100.

A person ordinarily skilled in the art may appreciate that the vehicle 100 may conserve vehicle power (e.g., vehicle battery power and/or fuel usage) by automatically switching OFF vehicle units when the vehicle 100 detects absence of occupant inside the vehicle 100 or at one or more sitting areas in the vehicle 100. For example, the vehicle 100 may conserve vehicle power by switching OFF the rear air conditioning vent or sitting area buckle sensor when the vehicle 100 detects absence of occupant at the vehicle rear sitting area 106.

In some aspects, the scanning unit 108 may include one or more radar sensors (not shown) that may be configured to scan the interior vehicle portion and detect the user 102 presence. The radar sensor may be a Multiple Input Multiple Output (MIMO) phase shifting radar sensor that may include a plurality of transmitting and receiving antennas. Each transmitting antenna may transmit a radar beam/wave that may reflect from an object (e.g., the user 102). Each receiving antenna may be configured to capture/receive the reflected wave, and send the reflected wave to a vehicle processor (not shown). The vehicle processor may detect the user 102 presence (or absence) in response to receiving the reflected wave, and may control usage of the plurality of vehicle units to optimize vehicle power consumption based on the detection, as described above.

The scanning unit 108 may use vehicle power when the radar sensor scans the vehicle interior portion. The vehicle power usage may be based on a plurality of parameters such as a frequency of scans that the radar sensor may perform, a count of transmitting antennas and/or receiving antennas that the radar sensor may use for the scans, and/or the like.

In some aspects, in addition to controlling vehicle unit/component usage, the vehicle processor may optimize vehicle power consumption by controlling scanning unit 108 operation. In an exemplary aspect, the vehicle processor may control the scanning unit 108 operation by determining an optimum scanning unit setting in which the scanning unit 108 may operate, based on one or more inputs that the vehicle processor may obtain from various vehicle sensors and/or historical vehicle usage trend information (that may be stored in a vehicle memory). For example, the vehicle processor may cause the scanning unit 108 to operate or start scanning in a low fidelity (power) operation mode when the vehicle processor detects a trigger event, and switch to a high fidelity (power) operation mode when the scan using the low fidelity operation mode indicates no occupant presence in the vehicle.

To explain further the example mentioned above, the vehicle processor may set the scanning unit setting to the low fidelity operation mode when the vehicle processor detects a trigger event, e.g., vehicle door opening or closing. The trigger event may indicate that the user 102 may enter or exit the vehicle 100, and hence the vehicle processor may cause the scanning unit 108 to scan the vehicle interior portion (in the low fidelity operation mode) to detect the user 102 presence in the vehicle 100. In some aspects, the scanning unit 108 may use a subset of transmitting antennas and receiving antennas (and not all transmitting/receiving antennas) in the low fidelity operation mode to scan the vehicle interior portion. For example, if the scanning unit 108 includes three transmitting antennas and four receiving antennas, the scanning unit 108 may use two transmitting and receiving antennas in the low fidelity operation mode to scan the vehicle interior portion. As described above, the transmitting antennas may transmit radar waves, and the receiving antennas may receive radar waves reflected from objects, e.g., vehicle occupants.

The vehicle processor may receive the reflected radar waves from the scanning unit 108 in the low fidelity operation mode, and may detect the user 102 presence (or absence) in the vehicle 100 based on the reflected waves. In some aspects, the vehicle processor may cause the scanning unit 108 to stop (deactivate) scanning the vehicle interior portion when the vehicle processor detects the user 102 presence based on the reflected radar waves. In this manner, the vehicle processor may detect the user 102 presence in the vehicle 100 by using the low fidelity operation mode of the scanning unit 108, and may hence conserve the vehicle power consumption (as all scanning unit transmitting/receiving antennas are not used in the low fidelity operation mode). In some aspects, the scanning unit 108 may detect adults or occupants with deep breathing in the low fidelity operation mode.

On the other hand, in some aspects, the vehicle processor may cause the scanning unit 108 to switch to the high fidelity operation mode (e.g., cause the scanning unit 108 to scan using all transmitting/receiving antennas) when the scan via the low fidelity operation mode indicates no occupant presence in the vehicle 100. The scanning unit 108 may detect children or pets (with low breathing rate) in the high fidelity operation mode. A person ordinarily skilled in the art may appreciate that the vehicle processor may cause the scanning unit 108 to switch operation modes to ensure that no occupant presence is missed by the scanning unit 108.

The vehicle processor may implement additional scanning unit operation control strategies to conserve vehicle power. For example, the vehicle processor may cause the scanning unit 108 to commence scanning with a predefined delay after detecting the trigger event, based on a trigger event type. For example, the vehicle processor may cause the scanning unit 108 to commence scanning after four to ten seconds of detecting vehicle door closing or opening. The delay may ensure that the occupants (e.g., the user 102) completely enter or exit the vehicle 100, before the scanning unit 108 scans the vehicle interior portion. This strategy ensures that the scanning unit 108 does not utilize vehicle power in scanning, until the occupants are settled in the vehicle 100 or fully exit the vehicle 100.

In another aspect, the vehicle processor may cause the scanning unit 108 to scan the interior vehicle portion in a predetermined order, based on the trigger event type and/or the historical vehicle usage information. For example, the vehicle processor may cause the scanning unit 108 to first scan the vehicle driver sitting area 104 (in the low fidelity operation mode) and then scan the vehicle rear sitting area 106. The vehicle processor may cause the scanning unit 108 to scan the vehicle driver sitting area 104 first, when the trigger event is associated with vehicle driver side door opening or when the historical vehicle usage information indicates that the user 102a usually drives alone in the vehicle 100 (e.g., during morning times when the user 102a may be going to the office).

In the aspect described above, the vehicle processor may cause the scanning unit 108 to create a focused radar beam that can be steered by the vehicle processor to scan different vehicle areas in the predetermined order. Specifically, the vehicle processor may use beam forming and beam steering techniques to change radar beam direction/orientation and focus on specific vehicle areas (e.g., the vehicle driver sitting area 104, the vehicle rear sitting area 106, etc.).

The vehicle processor may increase probability of detecting the user 102 presence in the vehicle 100 quickly by causing the scanning unit 108 to scan in the predetermined order, as described above. Vehicle portions where the probability of detecting the user 102 presence is more are scanned first, resulting in quicker occupant detection and hence less usage of vehicle power by the scanning unit 108. As described above, the vehicle processor may cause the scanning unit 108 to stop the scan when the user 102 presence is detected.

In yet another aspect, the vehicle processor may control scanning unit scan frequency to conserve vehicle power, based on the trigger event type. For example, when the trigger event is key off operation, the vehicle processor may cause the scanning unit 108 to scan in the high fidelity operation mode when the trigger event is detected, and then scan every five or ten minutes (e.g., in the low fidelity operation mode) to detect if someone is inadvertently left behind in the vehicle 100. The vehicle processor may eventually cause the scanning unit 108 to cease the scan after 20 or 30 minutes if no occupant is detected (or may cause the scanning unit 108 to scan a last time in the high fidelity operation mode before ceasing the scan).

On the other hand, the vehicle processor may immediately increase the scanning unit scan frequency when the vehicle processor detects a different type of trigger event. For example, the vehicle processor may increase scan frequency (e.g., from scanning every five minutes to scanning every 100 ms), when the vehicle processor detects a vehicle door opening trigger event.

A person ordinarily skilled in the art may appreciate that in a conventional occupant detection system, the radar sensors may scan frequently (e.g., every 100 ms) for 30 minutes in the high fidelity operation mode irrespective of the trigger event type. For example, the radar sensors in the conventional system may continue to scan every 100 ms for 30 minutes even after the key off operation. The present disclosure provides a system using which the vehicle processor controls radar sensor/scanning unit scan frequency based on the trigger event type, and combines the scan frequency control with low/high fidelity operation mode control, to optimize the vehicle power consumption.

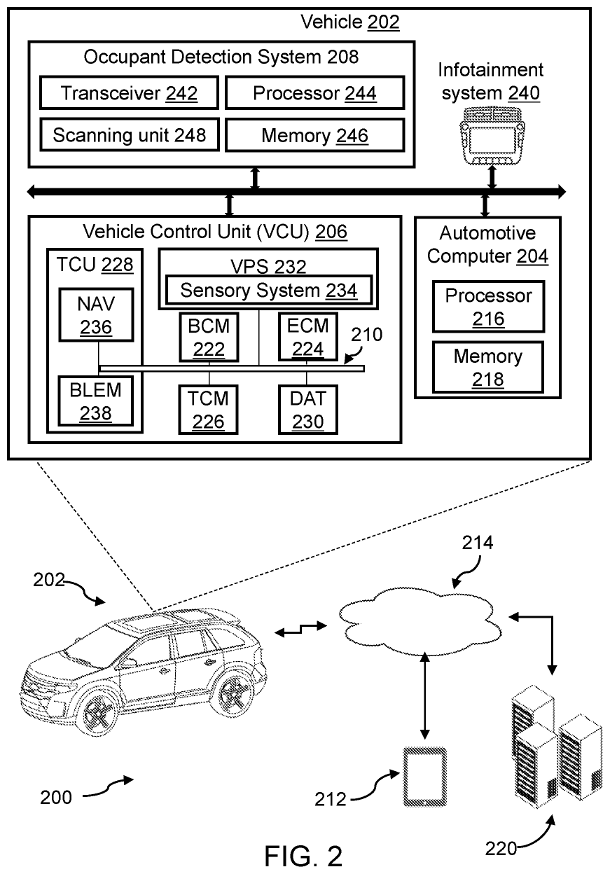

The various vehicle power conservation strategies, as described above, are explained in further detail in conjunction with FIG. 2.

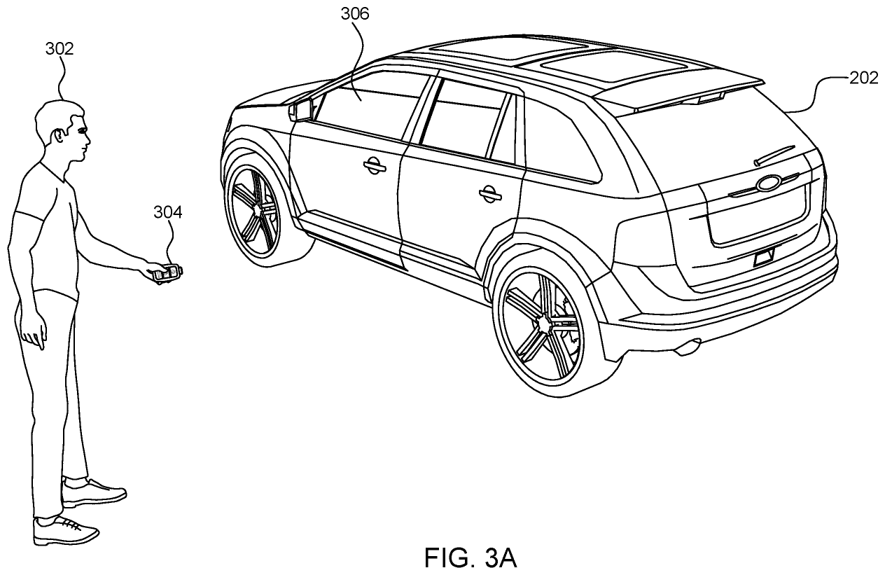

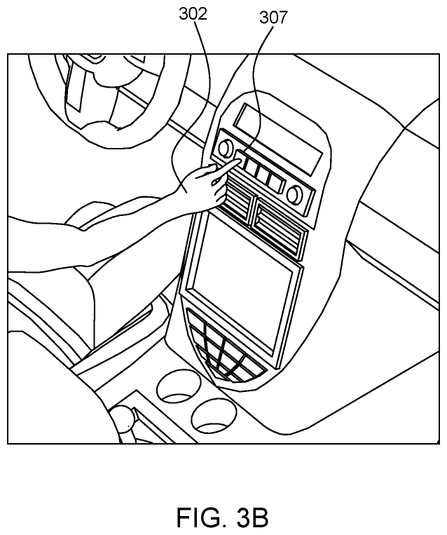

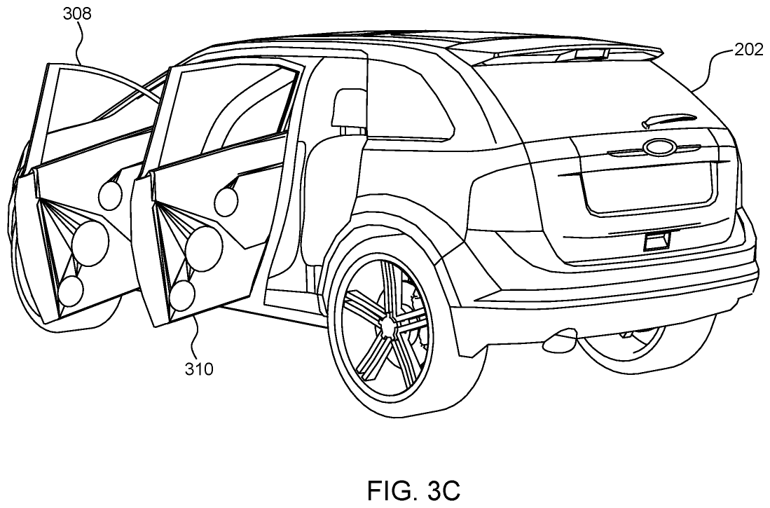

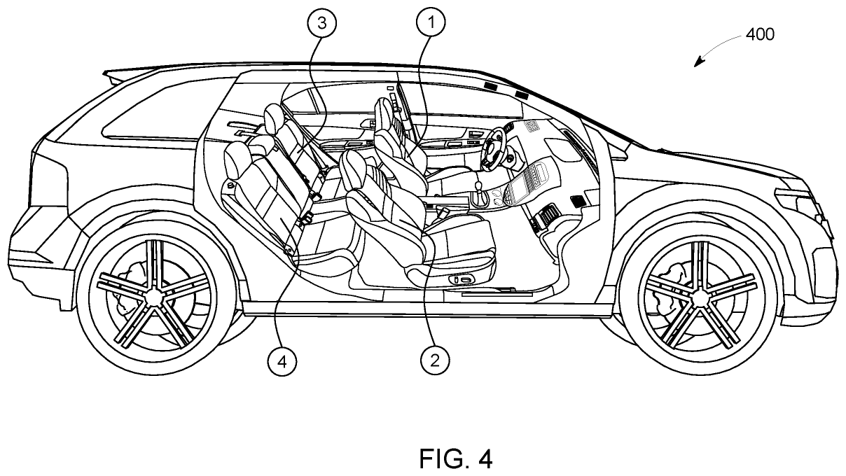

FIG. 2 depicts a system 200 to optimize a scanning unit operation in a vehicle 202, in accordance with the present disclosure. While describing FIG. 2, references may be made to FIGS. 3A, 3B, 3C and 4.

The vehicle 202 may include an automotive computer 204, a Vehicle Control Unit (VCU) 206, and an occupant detection system 208. The VCU 206 may include a plurality of Electronic Control Units (ECUs) 210 disposed in communication with the automotive computer 204.

The system 200 may include a mobile device 212 that may connect with the automotive computer 204 and/or the occupant detection system 208 by using wired and/or wireless communication protocols and transceivers. In some aspects, the mobile device 212 may be associated with a vehicle user/operator (not shown in FIG. 2). The mobile device 212 may communicatively couple with the vehicle 202 via one or more network(s) 214, which may communicate via one or more wireless connection(s), and/or may connect with the vehicle 202 directly by using near field communication (NFC) protocols, Bluetooth® protocols, Wi-Fi, Ultra-Wide Band (UWB), and other possible data connection and sharing techniques.

The network(s) 214 illustrates an example communication infrastructure in which the connected devices discussed in various embodiments of this disclosure may communicate. The network(s) 214 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the automotive computer 204 and/or some components of the occupant detection system 208 may be installed in a vehicle engine compartment (or elsewhere in the vehicle 202), in accordance with the disclosure. Further, the automotive computer 204 may operate as a functional part of the occupant detection system 208. The automotive computer 204 may be or include an electronic vehicle controller, having one or more processor(s) 216 and a memory 218. Moreover, the occupant detection system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable memory storing a scanning unit optimization program code. The memory 218 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

In some aspects, the automotive computer 204 and/or the occupant detection system 208 may be disposed in communication with one or more server(s) 220, and the mobile device 212. The server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In some aspects, the server 220 may also store vehicle 202 historical usage information. For example, the server 220 may store information associated with travel routes traversed by the vehicle 202 in the past one week, one month, one quarter, and/or the like, occupants (e.g., adults, children, and pets) who generally travel in the vehicle 202, vehicle sitting areas that are generally occupied in the vehicle 202, etc.

In accordance with some aspects, the VCU 206 may share a power bus with the automotive computer 204, and may be configured and/or programmed to coordinate the data between vehicle 202 systems, connected servers (e.g., the server(s) 220), and other vehicles (not shown in FIG. 2) operating as part of a vehicle fleet. The VCU 206 can include or communicate with any combination of the ECUs 210, such as, for example, a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, etc.

In some aspects, the VCU 206 may control vehicle 202 operational aspects and implement one or more instruction sets received from the mobile device 212, from one or more instruction sets stored in computer memory 218 of the automotive computer 204, including instructions operational as part of the occupant detection system 208.

The TCU 228 can be configured and/or programmed to provide vehicle connectivity to wireless computing systems onboard and off board the vehicle 202, and may include a Navigation (NAV) receiver 236 for receiving and processing a GPS signal, a BLE® Module (BLEM) 238, a Wi-Fi transceiver, a UWB transceiver, and/or other wireless transceivers (not shown in FIG. 2) that may be configurable for wireless communication between the vehicle 202 and other systems (e.g., a vehicle key fob, not shown in FIG. 2), computers, and modules. The TCU 228 may be disposed in communication with the ECUs 210 by way of a bus.

In one aspect, the ECUs 210 may control aspects of vehicle operation and communication using inputs from human drivers, inputs from an autonomous vehicle controller, the occupant detection system 208, and/or via wireless signal inputs received via the wireless connection(s) from other connected devices, such as the mobile device 212, the server(s) 220, among others.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, a vehicle fragrance system, door locks and access control, vehicle energy management, and various comfort controls. The BCM 222 may also operate as a gateway for bus and network interfaces to interact with remote ECUs (not shown in FIG. 2).

In some aspects, the DAT controller 230 may provide Level-1 through Level-3 automated driving and driver assistance functionality that can include, for example, active parking assistance, trailer backup assistance, adaptive cruise control, lane keeping, and/or driver status monitoring, among other features. The DAT controller 230 may also provide aspects of user and environmental inputs usable for user authentication.

In some aspects, the automotive computer 204 may connect with an infotainment system 240 that may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications, navigation maps, etc. on the touchscreen interface portion.

The computing system architecture of the automotive computer 204, the VCU 206, and/or the occupant detection system 208 may omit certain computing modules. It should be readily understood that the computing environment depicted in FIG. 2 is an example of a possible implementation according to the present disclosure, and thus, it should not be considered limiting or exclusive.

In accordance with some aspects, the occupant detection system 208 may be integrated with and/or executed as part of the ECUs 210. The occupant detection system 208, regardless of whether it is integrated with the automotive computer 204 or the ECUs 210, or whether it operates as an independent computing system in the vehicle 202, may include a transceiver 242, a processor 244, a computer-readable memory 246 and a scanning unit 248 (same as the scanning unit 108 of FIG. 1). The transceiver 242 may be configured to receive information/inputs from external devices or systems, e.g., the mobile device 212, the server 220, and/or the like. Further, the transceiver 242 may transmit notifications (e.g., alert/alarm signals, vehicle occupancy information, etc.) to the external devices or systems.

The processor 244 and the memory 246 may be same as or similar to the processor 216 and the memory 218, respectively. Specifically, the processor 244 may utilize the memory 246 to store programs in code and/or to store data for performing aspects in accordance with the disclosure. The memory 246 may be a non-transitory computer-readable memory storing the scanning unit optimization program code.

In some aspects, the processor 244 may be an Artificial Intelligence (AI)-based processor that may use a neural network model (not shown) to execute occupant detection system operation. The neural network model may be stored in the memory 246. The neural network model may be a trained or unsupervised neural network model that may analyze the reflected radar waves/beams received by the processor 244 from the scanning unit 248, and facilitate the processor 244 to determine an occupant presence or absence, an occupant identity (e.g., adult, child, pet, luggage, etc.), identify a recognized person (e.g., a vehicle owner, a family member), and/or the like.

In one or more aspects, the neural network model may include electronic data, which may be implemented, for example, as a software component, and may rely on code databases, libraries, scripts, or other logic or instructions for execution of a neural network algorithm by the processor 244. The neural network model may be implemented as code and routines configured to enable a computing device, such as the occupant detection system 208, to perform one or more operations. In some aspects, the neural network model may be implemented using hardware including a processor, a microprocessor, a field-programmable gate array (FPGA), or an application-specific integrated circuit (ASIC). In other aspects, the neural network model may be implemented by using a combination of hardware and software.

Examples of the neural network model may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), a Long Short Term Memory (LSTM) network based RNN, CNN+ANN, LSTM+ANN, a gated recurrent unit (GRU)-based RNN, a fully connected neural network, a deep Bayesian neural network, a Generative Adversarial Network (GAN), and/or a combination of such networks. In some aspects, the neural network model may include numerical computation techniques using data flow graphs. In one or more aspects, the neural network model may be based on a hybrid architecture of multiple Deep Neural Networks (DNNs).

As described in conjunction with FIG. 1, the scanning unit 248 may include one or more radar sensors that may include a plurality of transmitting and receiving antennas. The radar sensor included in the scanning unit 248 may be same as the radar sensor included in the sensory system 234, or may be a separate and dedicated radar sensor configured to scan vehicle 202 interior portion and detect an occupant (e.g., the user 102) presence. Specifically, the scanning unit 248 may include a phase shifting radar sensor with an adaptive/variable scan rate that may be configured to scan/target different vehicle interior areas. For example, as described in conjunction with FIG. 1, the processor 244 may control scanning unit 248 operation and cause the scanning unit 248 to operate in different modes, scan different vehicle interior areas, change scan frequency, add an initial scan delay, etc., based on different trigger events associated with the vehicle 202 that the processor 244 may detect.

As described above, the processor 244 may control the scanning unit 248 operation to optimize vehicle 202 power consumption. In particular, the processor 244 may execute a plurality of different power optimization strategies to conserve vehicle 202 power consumption. One or more such power optimization strategies are described below. It is to be understood that the processor 244 may execute the power optimization strategies described below separately, or may execute the power optimization strategies in combination with each other. Stated another way, the power optimization strategies described below should not be construed as being mutually exclusive. Further, the order of describing the strategies below should not be construed as a priority order of the strategies, nor a sequential order of executing the strategies.

In some aspects, the processor 244 may determine an optimum scanning unit 248 setting on receipt of a trigger event. One or more examples of trigger events are shown in FIGS. 3A, 3B and 3C. Specifically, FIGS. 3A, 3B and 3C depict example embodiments of a trigger event in accordance with the present disclosure.

One example of a trigger event is shown in FIG. 3A where a user 302 may be approaching the vehicle 202 with a key fob 304. In this case, the processor 244 may receive an input from the TCU 228 (that may detect the key fob 304 approaching the vehicle 202) indicating that the user 302 may be approaching the vehicle 202. In some aspects, the TCU 228 may also indicate a location/direction of user movement or a vehicle portion to which the user 302 (specifically, the key fob 304) may be approaching. For example, the TCU 228 may use the NAV receiver 236 and/or use Bluetooth/cellular signal triangulation to determine whether the user 302 (with the key fob 304) may be approaching vehicle left front door, right front door, left rear door, right rear door, vehicle trunk, and/or the like.

On input receipt from the TCU 228, the processor 244 may determine the vehicle door (e.g., a vehicle driver door) that the user 302 might open and hence determine a vehicle sitting area (e.g., a driver sitting area) that the user 302 may occupy.

In some aspects, the processor 244 may also receive user 302 images from vehicle exterior cameras. The processor 244 may use the user 302 images and may match (by using the neural network model and/or via facial recognition) the received images with pre-stored user 302 images (that may be pre-stored in the memory 218, 246) to determine if the user 302 is a recognized person. For example, the processor 244 may determine whether the user approaching the vehicle 202 is the vehicle 202 owner or a family member. If the user 302 is a recognized person, the processor 244 may determine that a probability of the user 302 entering the vehicle 202 may be high.

Another example trigger event may be opening of a vehicle window 306 by using the key fob 304. The vehicle window 306 opening may also indicate to the processor 244 that the user 302 may enter the vehicle 202. The processor 244 may further determine whether the user 302 opens the front window or a rear window (e.g., a “window location”), to determine whether the user 302 may be expected to occupy a front vehicle sitting area or a rear vehicle sitting area.

Another example trigger event is shown in FIG. 3B where the user 302 may switch ON (or OFF) vehicle AC 307 (or the infotainment system 240). In this case, the VCU 206 may detect that the user 302 has switched ON the AC 307, and may provide an input to the processor 244 indicating that the AC 307 is switched ON (or OFF). Switching ON or OFF of vehicle AC 307 may indicate to the processor 244 that the user 302 may be present in the vehicle 202 interior portion.

Yet another example trigger event is shown in FIG. 3C where one or more vehicle doors may be opened. For example, the user 302 may manually (or via the key fob 304) open a vehicle front door 308 or a vehicle rear door 310. In this case, the VCU 206 may provide an input to the processor 244 indicating whether the vehicle front door 308 and/or the vehicle rear door 310 is opened. The VCU 206 may further indicate to the processor 244 whether vehicle left side or right side door is opened. As described above, opening of vehicle door may indicate to the processor 244 that the user 302 may be entering or exiting the vehicle 202.

Although FIGS. 3A, 3B and 3C depict just three example trigger events, other trigger events are within the present disclosure scope. Examples of other trigger events include, but are not limited to, key off operation, vehicle door closing, vehicle trunk opening/closing, switching ON/OFF of the infotainment system 240, and/or the like.

Responsive to detecting the trigger event and determining the trigger event type and location (e.g., rear door opening, front door opening, switching ON of AC, etc.), the processor 244 may determine the optimum scanning unit 248 operation setting and may transmit a control signal to the scanning unit 248 to operate in accordance with the scanning unit 248 operation setting. In some aspects, the setting may be associated with a fidelity operation mode, a scan order and/or a scan frequency for the scanning unit 248.

In one aspect (a first power optimization strategy), the processor 244 may transmit the control signal to the scanning unit 248 and cause the scanning unit 248 to operate in the low fidelity mode, when the processor 244 detects that the user 302 may be approaching the vehicle front door 308 or has opened the vehicle front door 308 (as shown in examples of FIGS. 3A and 3C).

In additional aspects (a second power optimization strategy), the processor 244 may cause the scanning unit 248 to commence low fidelity mode scanning after a predefined delay (e.g., five seconds) of detecting the trigger event, in order to provide time for the user 302 to settle-in in the vehicle 202. Commencing the scanning after the predefined delay may save vehicle power, as the scanning unit 248 does not scan the vehicle interior portion till the user 302 is settled in the vehicle 202 (or is expected to settle in the vehicle 202). The predefined delay may be different for different trigger event types. For example, for a door opening trigger event, the predefined delay may be in a range of four to ten seconds. For an AC switching ON/OFF trigger event, the predefined delay may be shorter, e.g., between 0.05 to 0.2 seconds. For a trigger event where the user 302 might be taking an infant out of the vehicle 202 (which may be detected via vehicle interior cameras, sitting area sensors, etc.), the predefined delay may be longer, e.g., in a range of 100 to 150 seconds.

In the aspect described above, the processor 244 may first fetch a mapping of different trigger event types with predefined delays from the memory 218/246 (that may pre-store the mapping), and may determine the predefined delay corresponding to the trigger event type detected by the processor 244. For example, if the detected trigger event is door opening, the processor 244 may determine the predefined delay to be of five seconds. Responsive to determining the predefined delay, the processor 244 may correspondingly “delay” outputting the control signal to the scanning unit 248 by five seconds, so that the scanning unit 248 may commence the scanning after five seconds of door opening.

In some aspects, the delay may also be based on trigger event initiation and completion. For example, if an “initial” trigger event is door opening, the processor 244 may cause the scanning unit 248 to commence the low fidelity mode scanning after or when the processor 244 detects a corresponding “completion” trigger event, e.g., door closing. In this case, the processor 244 may not output the control signal to the scanning unit 248 to commence the scanning till the door is closed.

In yet another aspect (a third power optimization strategy), the processor 244 may cause the scanning unit 248 to scan the vehicle interior portion in a predetermined sequential order. An exemplary snapshot of a vehicle interior portion is depicted in FIG. 4. Specifically, FIG. 4 depicts an exemplary snapshot of a vehicle interior portion 400 segregated into different Zones 1, 2, 3 and 4, in accordance with the present disclosure.

Based on the trigger event type, the processor 244 may cause the scanning unit 248 to scan the vehicle interior portion 400 in a sequential order such that the probability of quickly detecting an occupant in the vehicle 202 is enhanced. For example, if the trigger event is vehicle front door 308 opening, the processor 244 may cause the scanning unit 248 to scan Zone 1 first, followed by other Zones (e.g., 2, 3 and 4). Scanning Zone 1 first enhances probability of the scanning unit 248 detecting the occupant (e.g., the user 302) presence quickly, as the user 302 opened the vehicle front door 308 (and is hence expected to occupy the vehicle front sitting area).

In additional aspects, the processor 244 may fetch the historical vehicle usage information from the server 220 (or the memory 218/246 that may pre-store the historical vehicle usage information) and determine expected vehicle occupancy based on the historical vehicle usage information. For example, if the historical vehicle usage information indicates that the user 302 generally travels with a child and the child is generally located in Zone 3, the processor 244 may cause the scanning unit 248 to first scan Zone 1, then Zone 3, and then the remaining Zones to detect occupant presence inside the vehicle 202. In other aspects, the processor 244 may cause the scanning unit 248 to first scan Zone 3, followed by Zone 1, and then the remaining Zones, to give priority to detecting the child (as presence of children may require activation of additional vehicle units for children's comfort) in the vehicle 202.

In some aspects, the processor 244 may utilize the three power optimization strategies described above separately or in combination with each other. For example, in one aspect, the processor 244 may cause the scanning unit 248 to scan all Zones 1-4 together in the low fidelity mode, when the processor 244 detects the trigger event. In this case, the scanning unit 248 may scan the Zones 1-4 and send the reflected radar waves to the processor 244. The processor 244 may analyze the received radar waves (by using the neural network model) and determine whether the user 302 is present inside the vehicle 202. If the processor 244 determines that the user 302 is present in the vehicle, the processor 244 may send a control signal to the scanning unit 248 to deactivate the scanning unit 248 or cause the scanning unit 248 to stop further scanning, thus saving vehicle power. Further, since the scanning unit 248 uses only a subset of transmitting and receiving antennas in the low fidelity mode, the vehicle power consumption is optimized.

In another aspect, to further conserve vehicle power, the processor 244 may cause the scanning unit 248 to scan Zones 1 to 4 in a sequential order (based on probability of detecting an occupant), in the low fidelity mode, and with a predefined commencement delay as described above. In this case, the scanning unit 248 may start the scan in the low fidelity mode after the predefined commencement delay from Zone 1, and may stop the scan when the processor 244 determines that the user 302 is present in Zone 1. A person ordinarily skilled in the art may appreciate that by combining the first, the second and the third power optimization strategies, the processor 244 may conserve additional vehicle power.

In some aspects, the processor 244 may cause (by sending a control signal to) the scanning unit 248 to switch to the high fidelity operation mode when the processor 244 does not detect an occupant presence inside the vehicle 202 by using the low fidelity scan. Scanning using the high fidelity operation mode may ensure that no occupant is inadvertently missed in the low fidelity scan.

In further aspects, the processor 244 may cause the scanning unit 248 to switch to the high fidelity operation mode even when the processor 244 detects an occupant (e.g., the user 302) presence inside the vehicle 202 by using the low fidelity scan. In this case, the scanning unit 248 may detect adults inside the vehicle 202 by using the low fidelity scan; however, to ensure that the scanning unit 248 did not miss any children or pets during the low fidelity scan, the processor 244 may cause the scanning unit 248 to scan in the high fidelity operation mode. In some aspects, the processor 244 may detect children or pet presence in the vehicle 202 by detecting respiratory rate, movement, etc. of the occupants as identified from the high fidelity scan that the scanning unit 248 may perform.

In yet another aspect (a fourth power optimization strategy), the processor 244 may control scanning unit 248 scan frequency based on the trigger event type. For example, if the trigger event indicates that the vehicle 202 usage may be complete, the processor 244 may cause the scanning unit 248 to scan the vehicle interior portion in the high fidelity operation mode when the processor 244 detects the trigger event and then decrease scanning unit 248 scan frequency. The processor 244 may determine that the vehicle 202 usage may be complete when the trigger event is associated with key off operation, closing of all vehicle doors, stopping of vehicle (as determined by vehicle movement, speed or gear status) or parking of vehicle in a parking lot (as determined by vehicle location via NAV receiver 236), or when a “final” trigger event associated with a vehicle 202 journey/route/usage is detected by the processor 244. For example, if an “initial” trigger event associated with the vehicle 202 journey/route/usage is opening of vehicle doors and entry of one or more occupants in the vehicle 202, the corresponding “final” trigger event may be exit of the one or more occupants from the vehicle 202 and closing of vehicle doors at the end of vehicle 202 journey/route/usage.

For the aspect mentioned above (e.g., when the vehicle 202 usage may be complete), the processor 244 may cause the scanning unit 248 to scan all Zones 1-4 together in the high fidelity operation mode initially, or may cause the scanning unit 248 to scan the Zones 1-4 in a sequential order based on vehicle occupancy information. In the latter case, the processor 244 may obtain vehicle occupancy information from the VCU 206 (e.g., from the sitting area sensors and/or interior vehicle cameras) to determine the sitting areas that were occupied before the key off operation or sitting areas where children or pets (if any) were located. The processor 244 may cause the scanning unit 248 to scan those sitting areas/zones first that were occupied before the key off operation.

A person ordinarily skilled in the art may appreciate that by causing the scanning unit 248 to scan initially in the high fidelity mode, the processor 244 may enhance the probability of detecting an occupant (e.g., a child or a pet) that may have been left behind inadvertently inside the vehicle 202. If the processor 244 detects the occupant in the scan, the processor 244 may send, via the transceiver 242, an alarm or an alert notification to the mobile device 212 (while still keeping key vehicle units, e.g., AC, lighting switched ON for occupant's comfort).

If the processor 244 does not detect any occupant in the initial high fidelity scan described above, the processor 244 may cause the scanning unit 248 to reduce scan frequency to every 5 minutes or 10 minutes for subsequent scans. In some aspects, the subsequent scan frequency may be higher or lower based on occupant type. For example, if children or pets were located inside the vehicle 202 before the key off operation, the subsequent scan frequency may be higher (e.g., every 2, 4 or 5 minutes). On the other hand, if no children or pets were inside the vehicle 202, the subsequent scan frequency may be lower (e.g., every 10 minutes).

Furthermore, the processor 244 may cause the scanning unit 248 to perform the subsequent scans in the low fidelity operation mode, to further save vehicle power. In an exemplary aspect, the processor 244 may cause the scanning unit 248 to perform a high fidelity scan a last time after a predetermined time (e.g., after 20 or 30 minutes of the key off operation) to ensure that no occupant is present inside the vehicle 202, before causing the scanning unit 248 to deactivate or stop subsequent scanning.

The processor 244 may further cause the scanning unit 248 to commence scanning in the low or the high fidelity mode and at an enhanced scan frequency, when a new trigger event (e.g., vehicle door opening) is detected.

In additional aspects, the processor 244 may modify the scanning unit 248 scan frequency based on user movement within the vehicle 202. For example, when all the users are settled in the vehicle 202 and the processor 244 has detected their presence (e.g., by using low or high fidelity scans), the processor 244 may reduce the scanning unit 248 scan frequency (e.g., from every 100 ms to every 5 or 10 minutes) for subsequent scans. On the other hand, if the processor 244 detects that the users are moving in the vehicle 202 or changing sitting areas frequently, the processor 244 may not modify the scan frequency or may modify the scan frequently with a less magnitude. For example, in this case, the processor 244 may reduce the scan frequency to every 1 minute.

The processor 244 may determine user movement within the vehicle 202 by performing micro Doppler movement effect analysis or by detecting changes in user position identified by interior vehicle cameras and/or sitting area sensors.

In further aspects, when the trigger event is associated with a user (e.g., the user 302) entering the vehicle 202, the processor 244 may stop the scanning unit 248 from scanning further when a single user presence is detected inside the vehicle 202. The trigger event associated with a user entering the vehicle 202 may be, for example, vehicle door opening after key off operation, switching ON of vehicle AC, etc. However, when the trigger event is associated with the user 302 leaving the vehicle 202, the processor 244 may not stop the scanning unit 248 from scanning further till the processor 244 ascertains that all vehicle occupants have left the vehicle 202. Stated another way, the processor 244 may not stop the scanning unit 248 from scanning further till the processor 244 ascertains that all vehicle sitting areas are vacated. Therefore, in the example described above, the processor 244 causes the scanning unit 248 to continue scanning even after the key off operation (e.g., till 20 to 30 minutes after the key off operation) to ascertain that no occupant is left behind in the vehicle 202.

In some aspects, the processor 244 may additionally determine who has left the vehicle 202 by using the interior vehicle cameras, and/or by using facial recognition techniques and the neural network model. In this manner, the processor 244 may ensure specifically that a child or a pet, who may have been present in the vehicle 202, has left.

As described in conjunction with FIG. 1, based on the detection of occupant presence or absence in the vehicle 202 as described above, the processor 244 may control operation of other vehicle units. For example, the processor 244 may control rear AC vent based on presence or absence of occupants in rear vehicle sitting areas, switch ON or OFF vehicle interior lights based on occupant presence or absence, and/or the like. A person ordinarily skilled in the art may appreciate that the processor 244 may conserve vehicle power by switching OFF or deactivating vehicle units that may not be required to be activated when no occupant is present. For example, the processor 244 may save vehicle power by deactivating rear sitting area sensors, sitting area buckle sensors, rear AC vents, etc., when no one is occupying the rear vehicle sitting areas.

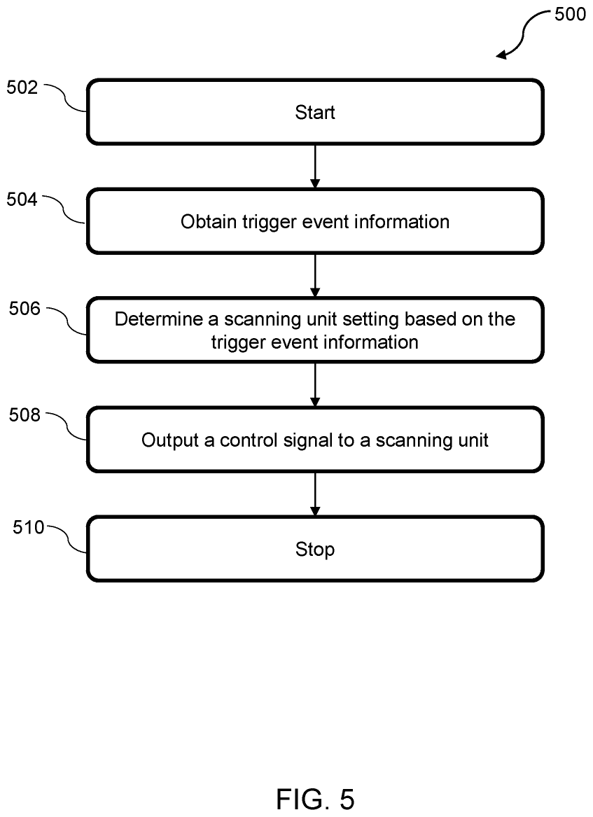

FIG. 5 depicts a flow diagram of an example method 500 for optimizing the scanning unit 248 operation in the vehicle 202, in accordance with the present disclosure. FIG. 5 may be described with continued reference to prior figures, including FIGS. 1-4. The following process is exemplary and not confined to the steps described hereafter. Moreover, alternative embodiments may include more or less steps that are shown or described herein and may include these steps in a different order than the order described in the following example embodiments.

Referring to FIG. 5, at step 502, the method 500 may commence. At step 504, the method 500 may include obtaining, by the processor 244, the trigger event information. The trigger information may include the trigger event type and trigger event location. As described above, the processor 244 may obtain the trigger event information from a detection unit (e.g., the sensory system 234 or the TCU 228 in the VCU 206).

Responsive to obtaining the trigger event information, at step 506, the method 500 may include determining, by the processor 244, the scanning unit 248 operation setting based on the trigger event information. As described above in conjunction with FIG. 2, the scanning unit 248 operation setting may be associated with the fidelity operation mode, the scan order and/or the scan frequency for the scanning unit 248. The processor 244 may determine the scanning unit 248 operation setting such that the vehicle 202 power consumption may be optimized.

At step 508, the method 500 may include outputting, by the processor 244, a control signal to the scanning unit 248 to scan the vehicle 202 interior portion based on the determined scanning unit 248 operation setting. The scanning unit 248 may then scan the vehicle 202 interior portion and transmit the reflected radar waves to the processor 244. The processor 244 may analyze the reflected radar waves (e.g., by using the neural network model) to determine the occupant presence or absence in the vehicle 202. Responsive to determining the occupant presence/absence, the processor 244 may control operation of various vehicle units, as described above.

The method 500 stops at step 510.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a scanning unit configured to scan and detect an occupant presence in a vehicle interior portion;
a detection unit configured to detect a trigger event;
a processor communicatively coupled with the scanning unit and the detection unit; and
a memory for storing executable instructions, the processor programmed to execute instructions to:
obtain trigger event information from the detection unit;
determine a scanning unit setting based on the trigger event information, wherein the scanning unit setting is associated with at least one of a scan order, a fidelity mode and a scan frequency associated with the scanning unit; and
output a control signal to the scanning unit to scan the vehicle interior portion based on the scanning unit setting.

2. The vehicle of claim 1, wherein the trigger event information comprises a trigger event type and a trigger event location in the vehicle or in a vehicle proximity.

3. The vehicle of claim 1, wherein the processor is further configured to obtain an occupant status information from the scanning unit in response to scanning the vehicle interior portion.

4. The vehicle of claim 3, wherein the processor is further configured to deactivate the scanning unit when the occupant status information indicates the occupant presence.

5. The vehicle of claim 3, wherein the scanning unit comprises a radar sensor comprising a plurality of transmitting antennas and a plurality of receiving antennas.

6. The vehicle of claim 5, wherein the fidelity mode comprises a high fidelity mode and low fidelity mode.

7. The vehicle of claim 6, wherein the scanning unit operates in the high fidelity mode when the plurality of transmitting antennas and the plurality of receiving antennas operate to scan the vehicle interior portion.

8. The vehicle of claim 6, wherein the scanning unit operates in the low fidelity mode when a set of transmitting antennas from the plurality of transmitting antennas, and a set of receiving antennas from the plurality of receiving antennas operate to scan the vehicle interior portion.

9. The vehicle of claim 6, wherein the processor is further configured to transmit control instructions, based on the occupant status information, to at least one of:
the scanning unit to modify the scanning unit setting, or
a vehicle component to control a vehicle component operation.

10. The vehicle of claim 9, wherein the processor is configured to modify the scanning unit setting from the low fidelity mode to the high fidelity mode or from the high fidelity mode to the low fidelity mode based on occupant presence detection.

11. The vehicle of claim 1, wherein the vehicle interior portion is segregated into a plurality of interior portion zones.

12. The vehicle of claim 11, wherein the processor determines the scan order for the scanning unit based on at least one of: the trigger event information and a historical vehicle usage information, and wherein the scan order is associated with a sequential order of scanning of the plurality of interior portion zones.

13. The vehicle of claim 1, wherein the processor is further configured to:
determine a predefined delay to output the control signal to the scanning unit in response to the detection of the trigger event, wherein the predefined delay is based on the trigger event information; and
output the control signal to the scanning unit after the predefined delay.

14. A method to optimize occupant detection in a vehicle, the method comprising:
obtaining, by a processor, trigger event information from a detection unit, wherein the detection unit is configured to detect a trigger event;
determining, by the processor, a scanning unit setting of a scanning unit based on the trigger event information,
wherein the scanning unit is configured to scan and detect an occupant presence in a vehicle interior portion, and
wherein the scanning unit setting is associated with at least one of a scan order, a fidelity mode and a scan frequency associated with the scanning unit; and
outputting, by the processor, a control signal to the scanning unit to scan the vehicle interior portion based on the scanning unit setting.

15. The method of claim 14, wherein the trigger event information comprises a trigger event type and a trigger event location in the vehicle or in a vehicle proximity.

16. The method of claim 14 further comprising:
obtaining an occupant status information from the scanning unit in response to scanning the vehicle interior portion; and
based on the occupant status information, transmitting control instructions to at least one of:
the scanning unit to modify the scanning unit setting, or
a vehicle component to control a vehicle component operation.

17. The method of claim 14 further comprising:
determining a predefined delay to output the control signal to the scanning unit in response to the detection of the trigger event, wherein the predefined delay is based on the trigger event information; and
outputting the control signal to the scanning unit after the predefined delay.

18. The method of claim 14 further comprising determining the scan order for the scanning unit based on at least one of: the trigger event information and a historical vehicle usage information.

19. The method of claim 18, wherein the scan order is associated with a sequential order of scanning a plurality of zones of the vehicle interior portion.

20. A non-transitory computer-readable storage medium having instructions stored thereupon which, when executed by a processor, cause the processor to:
obtain trigger event information from a detection unit, wherein the detection unit is configured to detect a trigger event;
determine a scanning unit setting of a scanning unit based on the trigger event information,
wherein the scanning unit is configured to scan and detect an occupant presence in a vehicle interior portion, and
wherein the scanning unit setting is associated with at least one of a scan order, a fidelity mode and a scan frequency associated with the scanning unit; and
output a control signal to the scanning unit to scan the vehicle interior portion based on the scanning unit setting.
